(19) United States
(12) Patent Application Publication
(10) Pub. No.: US 2020/0023723 A1
(43) Pub. Date: Jan. 23, 2020

(54) Safety Windshield Molding System

(71) Applicant: Wade Ferguson, Green River, WY (US)

(72) Inventor: Wade Ferguson, Green River, WY (US)

(21) Appl. No.: 16/519,412

(22) Filed: Jul. 23, 2019

Related U.S. Application Data
(60) Provisional application No. 62/702,033, filed on Jul. 23, 2018.

(51) Int. Cl. B60J 10/27; B60J 10/70; B60J 10/15

(52) U.S. Cl. CPC B60J 10/27; B60J 10/15; B60J 10/70

(57) ABSTRACT

A safety windshield molding system. The system includes a flexible body including three distinct channels. A first channel is configured to receive and frictionally engage the perimeter edge of a windshield glass. A second channel is configured to receive and frictionally engage an edge of a body of a cabin at a window opening. A third channel is configured to frictionally engage a locking strip, which secures the windshield glass in place. The windshield glass includes a surface area that is greater than a surface area of the window opening, such that the flexible body maintains the windshield glass in a position that is entirely exterior to the cabin. This positioning prevents the windshield glass from being forced into the cabin when an impact force is applied to the windshield glass, thereby protecting the operator seated within the cabin.

### CROSS REFERENCE TO RELATED APPLICATIONS

This application claims the benefit of U.S. Provisional Application No. 62/702,033 filed on Jul. 23, 2018. The above identified patent application is herein incorporated by reference in its entirety to provide continuity of disclosure.

### BACKGROUND OF THE INVENTION

The present invention relates to windshield molding systems. More specifically, the present invention provides a safety windshield molding system that is specifically configured to support a windshield glass having a larger overall surface area than a window opening exteriorly to a cabin, such than an impact made to the windshield glass is prevented from forcing the windshield glass into the cabin.

Powered utility machines or equipment which require an operator seated within a cabin, including construction or mining machines such as loaders, excavators, drill rigs, crushers, and the like, almost always have at least one windshield or other fixed transparent window, which is typically composed of a durable glass material. The windshield allows the machine operator to observe the surroundings outside of the cabin, while providing a shield from debris that would otherwise enter the cabin and potentially harm the operator. Improvements have been made to make windshields safer and further protect the operator of the machinery. Particularly, many structural improvements have been made that prevent windshields from shattering on impact. However, such improvements also lead to particular drawbacks. When an impact force is imparted against a shatter-proof windshield, the entire windshield has the tendency to remain intact and move as a single object. When the windshield glass is forced inwardly into the cabin of the machinery, injury can occur to the cabin occupants.

In the mining and construction industry, windshields of all types of cabin-based work equipment are very likely to be hit with various objects. Particularly when underground, there is a constant risk of falling rocks and other debris. Such debris often strikes utility machinery such as front end loaders, backhoes, loaders, rock breakers, crusher and screen systems, and the like. When this debris makes a forceful enough impact, the entire windshield can be dislodged from its internal molding and forced inwardly into the operator cabin, where it can impact against the operator and potentially cause serious harm. In view of the above concerns, it is desirable to provide a safety windshield molding system that prevents a windshield from being forced into the operator cabin when the windshield experiences a forceful impact.

Devices have been disclosed in the art that relate to safety windshield moldings. However, the present invention includes several structural and functional features that typical safety windshield moldings lack. For example, typical windshield moldings secure a windshield glass within a window opening, such that the windshield glass is smaller in size than the window opening, allowing it to fit therein. However, the present invention provides a windshield molding that maintains a windshield glass that is larger than the window opening at a position that is entirely exterior to the window opening.

In light of the devices disclosed in the art, it is submitted that the present invention substantially diverges in design elements from the prior art and consequently it is clear that there is a need in the art for an improvement to existing safety windshield molding systems. In this regard the present invention substantially fulfills these needs.

### SUMMARY OF THE INVENTION

In view of the foregoing disadvantages inherent in the known types of safety windshield molding systems now present in the prior art, the present invention provides a safety windshield molding system wherein the same can be utilized for providing convenience for the user when safely securing a windshield over a window opening of an machine's operator cabin. In an exemplary embodiment, the safety windshield molding system includes a flexible body having a first channel, a second channel, and a third channel. The first channel is configured to receive and frictionally engage the edge of a windshield glass. The second channel is configured to receive and frictionally engage an edge of a frame of a machine having an operator cabin. The third channel is configured to receive and frictionally engage a locking strip. The flexible body is configured to support a windshield glass that includes a surface area greater than a surface area of a window opening of a frame of the machine such that the windshield glass is positioned externally to an interior cabin portion of the frame of the machine.

Other objects, features, and advantages of the present invention will become apparent from the following detailed description taken in conjunction with accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross sectional view of the flexible body of an embodiment of the safety windshield molding system.

FIG. 2 shows a cross sectional view of an embodiment of the safety windshield molding system in use.

### DETAILED DESCRIPTION OF THE INVENTION

Reference is made herein to the attached drawings. Like reference numerals are used throughout the drawings to depict like or similar elements of the safety windshield molding system. For the purposes of presenting a brief and clear description of the present invention, the preferred embodiment will be discussed as used for securing a windshield having an overall surface area greater than that of the machine cabin's window opening exteriorly to the machine's cabin, such that the windshield is prevented from being forced into the cabin during an impact. The figures are intended for representative purposes only and should not be considered to be limiting in any respect.

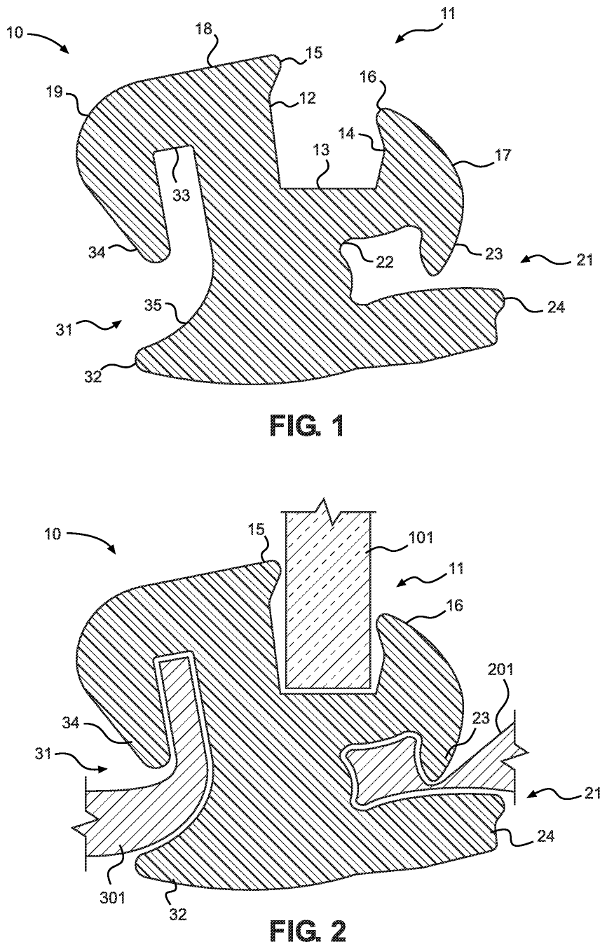

Referring now to FIG. 1, there is shown a cross sectional view of the flexible body of an embodiment of the safety windshield molding system. The windshield molding system generally comprises a flexible body 10 that is configured to secure a glass or similarly structured windshield or window to a machine frame or body. In this context, the term “machine” may include, but is not limited to, construction and mining equipment such as crushers and screens, drill rigs, loaders, excavators, and the like. The present invention can be utilized in any type of machinery that includes an operator cabin having one or more window openings for supporting a transparent windshield or window. In an exemplary embodiment, the flexible body 10 is composed of rubber for its flexible, waterproof, and resilient properties. The flexible body 10 can be manufactured via extrusion methods and can be made to a desired length depending upon the size of cabin window opening involved. The flexible body 10 can be unitary in construction or may have multiple disconnected sections that are secured in place during installation.

The flexible body 10 includes a first channel 11, a second channel 21, and a third channel 31. The first channel 11 is configured to receive and frictionally engage the edge of a windshield glass so as to secure the windshield glass to the flexible body 10. The second channel 21 is configured to receive and frictionally engage an edge of a frame of a machine's operator cabin. The third channel 31 is configured to receive and frictionally engage a locking strip. Generally, the flexible body 10 is configured to support a windshield glass that includes a surface area greater than a surface area of a window opening of a cabin frame such that the windshield glass is positioned externally to an interior cabin portion of the frame of the cabin.

The first channel is specifically adapted to frictionally engage an edge of a windshield or window glass. To that end, the first channel 11 comprises a first access opening leading to a first lower surface 13 bound between a pair of interior walls 12, 14. Each interior wall includes a lip 15, 16 that extends inwardly toward the opposing interior wall, and downwardly toward the lower surface 13. The opposing lips 15, 16 exert a force against the opposing sides of the window glass in order to frictionally secure the window glass in place. In the shown embodiment, a first interior wall 12 includes a height greater than a height of a second interior wall 14. The offset heights of the interior walls 12, 14 help to further secure the window glass and prevent unwanted movement thereof.

The second channel 21 is specifically adapted to frictionally engage an edge of a frame of a machine's operator cabin at a window opening thereof. The second channel 21 comprises a second access opening defined by an inwardly curving upper portion 23 and a first lower projection 24 extending in a direction opposing the second channel 21. An outwardly curved section 17 of the flexible body is disposed between the first channel 11 and the second channel 21. The outwardly curved section 17 of the flexible body 10 includes one of the first channel lips 16 and the inwardly curving upper portion 23 of the second channel. In the illustrated embodiment, the second channel 21 includes a plurality of offset interior corners 22, which help to further secure the operator cabin frame within the second channel 21.

The third channel 31 includes a third access opening bound by an inwardly curving tab 34 and a second lower projection 32 extending in a direction opposite the first lower projection 24. The section of the flexible body 10 disposed between the first and third channels 11, 31 includes a linear portion 18 extending from the first lip 15 of the first channel 11 and an inwardly curving portion 19 that terminates in the inwardly curving tab 34. The inwardly curving tab 34 is configured to bend and frictionally engage a locking strip inserted within the third channel 31, which locks the safety windshield molding system in place. Additionally, the third channel 31 includes a width that tapers inwardly from the third access 35 opening to an interior end wall 33. This shape allows the tab 34 to lock the locking strip within the third channel 31.

Referring now to FIG. 2, there is shown a cross sectional view of an embodiment of the safety windshield molding system in use. In the illustration, space is shown between the flexible body 10 and the secured components in order to understand the proportionate dimensions of the system, but it is to be understood that when in use, the components of the window system make contact with the interiors of the channels when installed in order to be secured therein via a friction fit. In use, a windshield or window glass 101 is frictionally secured within the first channel 21. The opposing lips 15, 16 exert pressure against the opposing sides of the window glass 101 in order to secure it in place. The cabin frame 201 is frictionally secured within the second channel 21. In the shown embodiment, the offset corners of the second channel 21 help to secure the flexible body 10 to the cabin frame 201. The inwardly curving upper portion 23 and first lower projection 24 exert pressure against the cabin frame 201 to effect frictional engagement therewith. The locking strip 301 is inserted into the third channel 31, such that the inwardly curving tab 34 compresses the locking strip 301 into the channel and against the second projection 32 on the lower end of the flexible body 10.

As shown by the positioning of the first and second channels 11, 21, the flexible body 10 is specially shaped and configured to support the window glass 101 separately and distinctly from the cabin frame 201. In operation, the present system is utilized with a pane of window glass 101 that is wider than the window opening on the frame 201 of the cabin. The shape of the flexible body 10 is such that the window glass 101 is supported entirely exteriorly to the cabin window opening. In other words, the cabin window opening includes a width and a height that is overall less than a width and height of the window glass 101. When an impact is made against the window glass 101, the exterior positioning of the window glass 101 will prevent the window glass 101 from being pushed into the interior of the cabin, since the glass itself is larger than the frame opening. In this way, the operator of the machinery is protected from potentially being struck by an inwardly moving window pane, increasing the safety for all machinery operators using the present invention.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A safety windshield molding system, comprising:
a flexible body having a first channel, a second channel, and a third channel;
the first channel configured to receive and frictionally engage the edge of a windshield glass;
the second channel configured to receive and frictionally engage an edge of a frame of a cabin of a machine;
the third channel configured to receive and frictionally engage a locking strip;
wherein the flexible body is configured to support a windshield glass that includes a surface area greater than a surface area of a window opening of a machine cabin frame such that the windshield glass is positioned externally to an interior cabin portion of the frame of a machine.

2) The safety windshield molding system of claim 1, wherein the flexible body is composed of rubber.

3) The safety windshield molding system of claim 1, wherein the first channel comprises a first access opening and a first lower surface bound between a pair of interior walls, wherein each interior wall includes a lip that extends inwardly toward the opposing interior wall.

4) The safety windshield molding system of claim 3, wherein the pair of interior walls comprises a first wall having a first height and a second wall having a second height that is less than the height of the first wall.

5) The safety windshield molding system of claim 1, wherein the second channel comprises a second access opening defined by a first inwardly curving upper portion and a first lower projection extending in a direction opposing the second channel.

6) The safety windshield molding system of claim 5, wherein the second channel comprises one or more offset interior corners.

7) The safety windshield molding system of claim 1, wherein the third channel comprises a third access opening bound by an inwardly curving tab and a second lower projection extending in a direction opposite the first lower projection.

8) The safety windshield molding system of claim 7, wherein the third channel comprises a width that tapers inwardly from the third access opening to an interior end wall.

9) The safety windshield molding system of claim 7, wherein the inwardly curving tab is configured to frictionally engage a locking strip inserted within the third channel.

10) A safety windshield molding system, comprising:
a flexible body having a first channel, a second channel, and a third channel;
a windshield glass frictionally secured within the first channel;
an edge of a frame of a cabin of a machine frictionally secured within the second channel;
a locking strip frictionally secured within the third channel;
wherein the windshield glass that includes a surface area greater than a surface area of a window opening of the frame of the machine;
wherein the windshield glass is positioned entirely externally to an interior cabin portion of the frame of a machine.

11) The safety windshield molding system of claim 10, wherein the flexible body is composed of rubber.

12) The safety windshield molding system of claim 10, wherein the first channel comprises a first access opening and a first lower surface bound between a pair of interior walls, wherein each interior wall includes a lip that extends inwardly toward the opposing interior wall.

13) The safety windshield molding system of claim 12, wherein the pair of interior walls comprises a first wall having a first height and a second wall having a second height that is less than the height of the first wall.

14) The safety windshield molding system of claim 10, wherein the second channel comprises a second access opening defined by a first inwardly curving upper portion and a first lower projection extending in a direction opposing the second channel.

15) The safety windshield molding system of claim 14, wherein the second channel comprises one or more offset interior corners that engage the edge of the frame of the cabin of the machine.

16) The safety windshield molding system of claim 10, wherein the third channel comprises a third access opening bound by an inwardly curving tab and a second lower projection extending in a direction opposite the first lower projection.

17) The safety windshield molding system of claim 16, wherein the third channel comprises a width that tapers inwardly from the third access opening to an interior end wall.

18) The safety windshield molding system of claim 16, wherein the inwardly curving tab frictionally engages the locking strip inserted within the third channel.
